(19) United States
(12) Patent Application Publication
(10) Pub. No.: US 2017/0017616 A1
(43) Pub. Date: Jan. 19, 2017

(54) Dynamic Cinemagraph Presentations

(71) Applicant: Apple Inc., Cupertino, CA (US)

(72) Inventors: Michel Elings, Palo Alto, CA (US); Tom E. Klaver, Mountain View, CA (US); Martin J. Murrett, Portland, OR (US)

(21) Appl. No.: 14/869,626

(22) Filed: Sep. 29, 2015

Related U.S. Application Data
(60) Provisional application No. 62/194,153, filed on Jul. 17, 2015.

(51) Int. Cl. G06F 17/21; G06F 3/0485; G06F 3/0481; G06T 3/40; G06F 17/22; G06F 3/0346; G06T 13/80

(52) U.S. Cl. CPC G06F 17/212; G06F 3/0346; G06F 3/0485; G06T 13/80; G06T 3/40; G06F 17/2247; G06F 3/0481

(57) ABSTRACT

Some embodiments provide a method that displays, on a display screen, a document with several candidate cinemagraph presentations for display. The method selects, based on a set of at least two criteria, at least one candidate cinemagraph presentation for display. The method displays the selected cinemagraph presentation with the document.

### BACKGROUND

Today, the competition between content publishers for the attention of the online viewers is quite aggressive. This is because there are many sources for the same type of content available through the Internet. In this competition, publishers need to differentiate their content from that of other publishers. Publishers also need to capture the viewers' attention to their content quickly. Otherwise, the viewers' attention may drift to the content of others.

### SUMMARY

Some embodiments of the invention provide novel methods for using cinemagraphs to produce visually stimulating document and/or document transitions. In some embodiments, a cinemagraph includes several images that have (1) one or more identical portions and (2) one or more portions that change across the images in order to provide an illusion of an animation within a still image. In some cases, the animation can include moving objects, changing colors in a scene, and/or appearing/disappearing objects in the scene. In some embodiments, the cinemagraph images loop iteratively or continuously. In some embodiments, cinemagraphs are defined as an animated GIF (Graphics Interchange Format) or in some other animated image format. Alternatively, or conjunctively, a cinemagraph in some embodiments can also be a video clip (i.e., a sequence of captured images) or an animated clip that is defined in a common video format. In some embodiments, a cinemagraph can be a hybrid of a still image and a video.

The documents on which the cinemagraph presentations of some embodiments are displayed can include articles, webpages, blog pages, audio/video content pages, etc. They can also include documents that provide summaries to other documents. Examples of these include article summaries, webpage summaries, blog summaries, or other content summaries. The cinemagraph presentations of some embodiments can also appear on documents that identify several document sources, such as article publishers, webpage publishers, blog publishers, video publishers, or other content publishers. These presentations can also be part of transitions between any of these types of documents, which may be linked to each other (e.g., through hyperlinks). In some embodiments, documents and document transitions are displayed by an application, such as a web browser, a document reader, a word processor, presentation application, etc. Such an application implements the method of some embodiments. In other cases, the method of some embodiments is implemented by another device (e.g., a server) that provides the documents and document transitions to the application that displays them.

Some embodiments provide novel methods for selecting the cinemagraph(s) to present on a document when there are multiple available candidate cinemagraphs for the document. For instance, some embodiments cycle through the cinemagraphs on the document to highlight different document sections, different document summaries and/or different document sources. These or other embodiments select the cinemagraphs to present by identifying a field of focus on the displayed document (e.g., identifying a region on a displayed page that is about the center of a display screen) and presenting one or more cinemagraphs on the document that have a particular positional relationship with the identified field of focus (e.g., are within or near the field of focus).

Some embodiments select cinemagraphs to present based on how recently the content was added to the displayed document or to a publication represented on the displayed document. For instance, when multiple candidate cinemagraphs are available on a document summary page, the method of some embodiments selects the cinemagraphs of the newer (more recent) document summaries. Similarly, when multiple candidate cinemagraphs are available on a document source page, the method of some embodiments selects the cinemagraphs of the document sources with the newer (more recent) published documents. For a document (e.g., a webpage or blog page) that has multiple sections that are added at different times, the method of some embodiments selects the cinemagraphs for the newer sections. Alternatively, the method of other embodiments may preferentially display the cinemagraphs of older document summaries or document sections that have not been previously viewed to draw a viewer's attention to these summaries or sections. Similarly, on a document source page, the method of some embodiments may display cinemagraphs for the document sources that have not been selected or have not been recently selected by the viewer.

The cinemagraph-presentation method of some embodiments selects the cinemagraphs to present based on user-specified preferences and/or user-detected preferences. Accordingly, for two users with different preferences, some embodiments present different cinemagraphs from the same group of cinemagraphs. The selection of the cinemagraphs based on user-defined preferences and/or user-detected preferences allows the method of some embodiments to present cinemagraphs to the user that are for documents, document summaries and/or document sources that the user will find more interesting.

Some embodiments detect the user's preference by keeping track of the document and/or document sources that the user has previously selected for viewing. To preserve the user's privacy, some of these embodiments do not store the document and/or document sources that the user selects, but rather use the user's selection to maintain metrics that quantify the user's preferences. For instance, each time the user selects a document, some embodiments (1) identify the document's type based on the document's metadata or content, and (2) based on the identified document type, adjust one or more metric values associated with one or more document categories to account for the selection of the document.

Similarly, some embodiments adjust document type metric values when a user selects a document source that is associated with one or more particular categories of documents. In some embodiments, document categories are topical categories that are used to categorize articles, article publishers, webpages, web publishers, blog pages, blog publishers, etc. The topical categories in some embodiments include fashion, technology, sports, entertainment, global politics, regional politics (e.g., U.S. politics, European politics, etc.), brands, etc.

Under this approach, some embodiments generate a profile for a user based on the user's selection of documents (e.g., articles) and/or document sources (e.g., electronic newspapers or magazines) over a time duration. In some embodiments, the user's profile is expressed in terms of a set of category metric values, such as topical categories that express the user's interests in various content types. For instance, for fashion, technology and sports categories, one user's profile might specify metric values of 5, 2, and 1, while another user's profile might specify metric values of 1, 2, and 3, where the metric values are expressed on a scale of 1 to 5, with 1 being the highest metric value. In some embodiments, the user profile is maintained on the device that displays the document, while in other embodiments, the user profile is maintained on a server that distributes the document to one or more devices. Also, some embodiments generate a particular user's profile not just based on the particular user's activities, but also based on the activities of other users associated with the particular user (e.g., users that are part of the same entity, or part of an online community, etc.). For instance, some embodiments define a user's profile based on content that the user's friends have “liked” online.

Instead of, or in addition to, selecting cinemagraphs based on user preferences, some embodiments dynamically select cinemagraphs to present based on document source preferences. For instance, in some embodiments, article publishers express a preference for the type of users that are a target audience for their articles and for the advertisements that are contained in their articles. For such cases, the cinemagraph-presentation method of some embodiments preferentially selects and displays the cinemagraphs for the different users by comparing the user profiles to the publisher expressed preferences. In some embodiments, the method accounts for advertising fees and/or other incentives provided by the publishers to preferentially display their cinemagraphs. In some embodiments, the publishers can request preferential cinemagraph displays (over content from other publishers) for all users, and not just certain target audience groups.

From multiple available candidate cinemagraphs for a document, some embodiments select the cinemagraph(s) to present on the document without receiving any user interface input to select a candidate cinemagraph presentation or to indicate a preference for a candidate cinemagraph presentation. These embodiments automatically select one candidate cinemagraph presentation based on one or more of the above-mentioned selection criteria. Some embodiments select the cinemagraph(s) without receiving any user interface input to indicate a preference for the candidate cinemagraph presentation after the document is displayed.

Some embodiments dynamically present a cinemagraph, or dynamically modify a cinemagraph presentation, based on input that is received on the device that presents the document associated with the cinemagraph. For instance, after receiving scroll input on a touch-sensitive display screen that displays a cinemagraph, some embodiments modify the cinemagraph (e.g., speed up or slow down movement of an object that is part of the cinemagraph) based on the speed of the scroll input. Alternatively, some embodiments start a cinemagraph presentation in response to scroll input on a touch-sensitive display screen.

Some embodiments start or modify cinemagraph presentations based on other types of inputs that are received on the device. For instance, in some embodiments, the document-displaying device is a mobile device with one or more motion sensors that detect rotational movements of the device. In some of these embodiments, a cinemagraph presentation is started or modified when a certain rotation movement (e.g., a movement that exceeds a threshold angle) of the device is detected based on the output of its motion sensor(s). In these or other embodiments, cinemagraph presentations are started or modified based on input from other sensors of the mobile device. After starting or modifying a cinemagraph presentation in response to received input (e.g., scroll input, sensor input, etc.), some embodiments terminate the cinemagraph presentation or stop modifying the cinemagraph presentation a time period after the received input ends.

Some embodiments of the invention provide novel methods for using cinemagraphs to produce visually stimulating document transitions. In some embodiments, an application (e.g., web browser, document reader, word processing application, presentation program, etc.) presents different documents on different pages (called document presentation pages below). In these or other embodiments, the application displays one or more document-source pages to present different document sources and one or more feed pages to provide summaries of documents from different sources or for a mixed group of sources.

When transitioning from a first page to a second page (e.g., from one webpage to another, from a document source page to a source feed page, from a feed page to a document presentation page, etc.), some embodiments provide an animation to visually illustrate this transition. When a cinemagraph presentation is in both the first page and the second page, some embodiments incorporate the cinemagraph presentation in the animated transition between the two pages. For instance, in some embodiments, the cinemagraph presentation continues to be displayed during the animated transition but its size is adjusted to account for a larger or smaller space that it occupies on the second page. Other embodiments stop the cinemagraph presentation during the page-to-page transition, but have the cinemagraph presentation start on the second page at the location that it stopped on the first page.

When the cinemagraph presentation appears on both the first and second pages (i.e., on the pages before and after the page transition), the cinemagraph presentation is identical on both pages in some embodiments. In other embodiments, the cinemagraph presentation on one page can differ from the cinemagraph presentation on the other page. For instance, in some embodiments, the cinemagraph presentation on the subsequent second page is more complex (e.g., contains more frames) than the cinemagraph presentation on the previous first page.

One example of this would be a cinemagraph presentation that appears on a document source page, a source feed page, and a document presentation page. The cinemagraph might have X frames on the document source page, Y frames on the source feed page, and Z frames on the document presentation page, where X, Y, and Z are integers, X is less than Y, and Y is less than Z. Under this approach, as the user directs the application to transition from the document source page to the source feed page and then to the document presentation page, the cinemagraph presentation becomes a richer presentation because the user's interest in the page associated with the cinemagraph has become clearer. In some embodiments, the first set of X frames is part of the second set of Y frames, which is part of the third set of Z frames. In other embodiments, the smaller sets of frames do not necessarily have to be subsumed by the larger set of frames. However, even in some of these embodiments, there are overlaps between each set of frames to ensure some continuity between the cinemagraph presentations on the different pages.

One of ordinary skill will realize that the preceding Summary is intended to serve as a brief introduction to some inventive features of some embodiments. Moreover, this Summary is not meant to be an introduction or overview of all-inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF DRAWINGS

The novel features of the invention are set forth in the appended claims. However, for purposes of explanation, several embodiments of the invention are set forth in the following figures.

FIG. 1 conceptually illustrates one such cinemagraph presentation process of some embodiments.

FIGS. 2-5 present several examples that explain the process of FIG. 1.

FIG. 6 illustrates a process that dynamically starts or modifies a cinemagraph presentation based on scroll input received by the device that displays the cinemagraph presentation.

FIG. 7 illustrates an example of stopping one cinemagraph presentation while starting another cinemagraph presentation in response to scroll input.

FIG. 8 illustrates an example of starting or modifying a cinemagraph presentation based on motion sensor input.

FIG. 9 illustrates an example that shows a cinemagraph presentation continuing to be displayed during the animated transition between a feed page and an article presentation page.

FIG. 10 illustrates an example that shows a cinemagraph presentation (1) stopping during an animated transition between a feed page and an article presentation page, and (2) resuming on page at the frame where it stopped on page.

FIGS. 11A and 11B illustrate one example of a cinemagraph presentation that gets gradually more complex as the content viewer steps through a series of linked documents that are displayed by a mobile device.

FIG. 12 illustrates an example of a cinemagraph presentation that achieves its animation by changing pixel color values.

FIG. 13 illustrates another example of a cinemagraph presentation that achieves its animation by changing pixel color values.

FIG. 14 illustrates an example of a cinemagraph that has objects fading in and out objects in a scene.

FIG. 15 is an example of an architecture of such a mobile computing device.

FIG. 16 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide novel dynamic cinemagraph presentations to produce visually stimulating documents. In some embodiments, a cinemagraph includes several images that have (1) one or more identical portions and (2) one or more portions that change across the images in order to provide an illusion of an animation within a still image. In some cases, the animation can include moving objects, changing colors in a scene, and/or appearing/disappearing objects in the scene. In some embodiments, the cinemagraph images loop iteratively or continuously. In some embodiments, cinemagraphs are defined as an animated GIF (Graphics Interchange Format) or in some other animated image format. Alternatively, or conjunctively, a cinemagraph in some embodiments can also be a video clip (i.e., a sequence of captured images) or an animated clip that is defined in a common video format. In some embodiments, a cinemagraph can be a hybrid of a still image and a video.

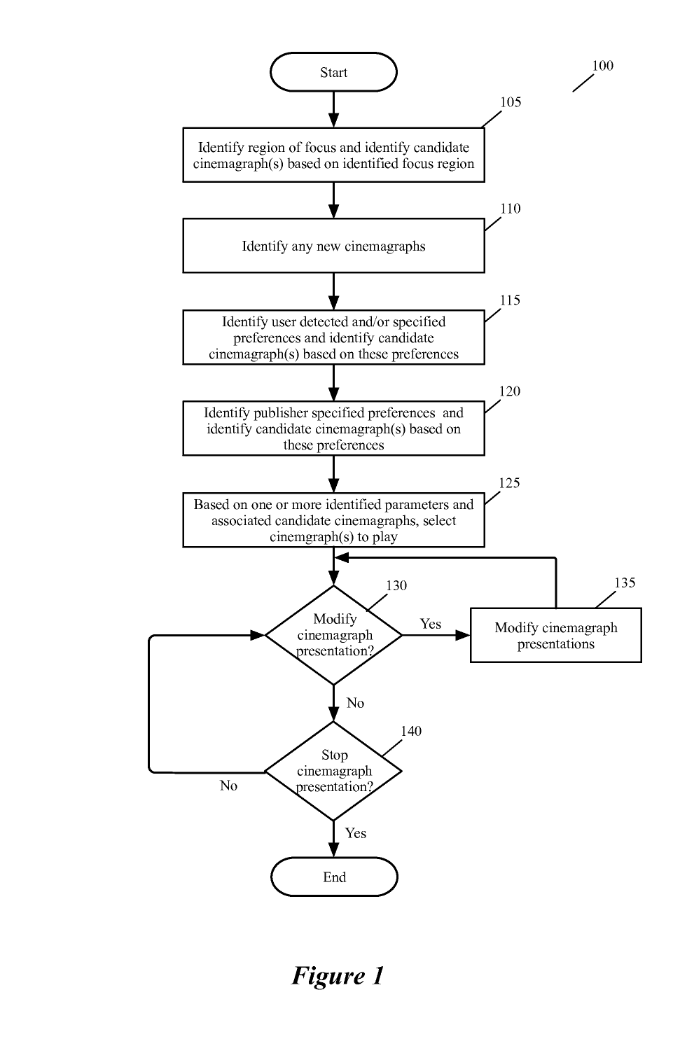

Some embodiments provide novel processes for selecting the cinemagraph(s) to present when there are multiple available candidate cinemagraphs for a document. FIG. 1 conceptually illustrates one such cinemagraph presentation process 100 of some embodiments. In some embodiments, a content presenting application (called content viewer below) performs the process 100 in order to identify the cinemagraph(s) to display from a group of candidate cinemagraphs that are available for presentation on a page that the application generates. In other embodiments, the process 100 is performed by other types of applications, such as browsers, browser-accessible server applications, word processing applications, presentation applications, etc.

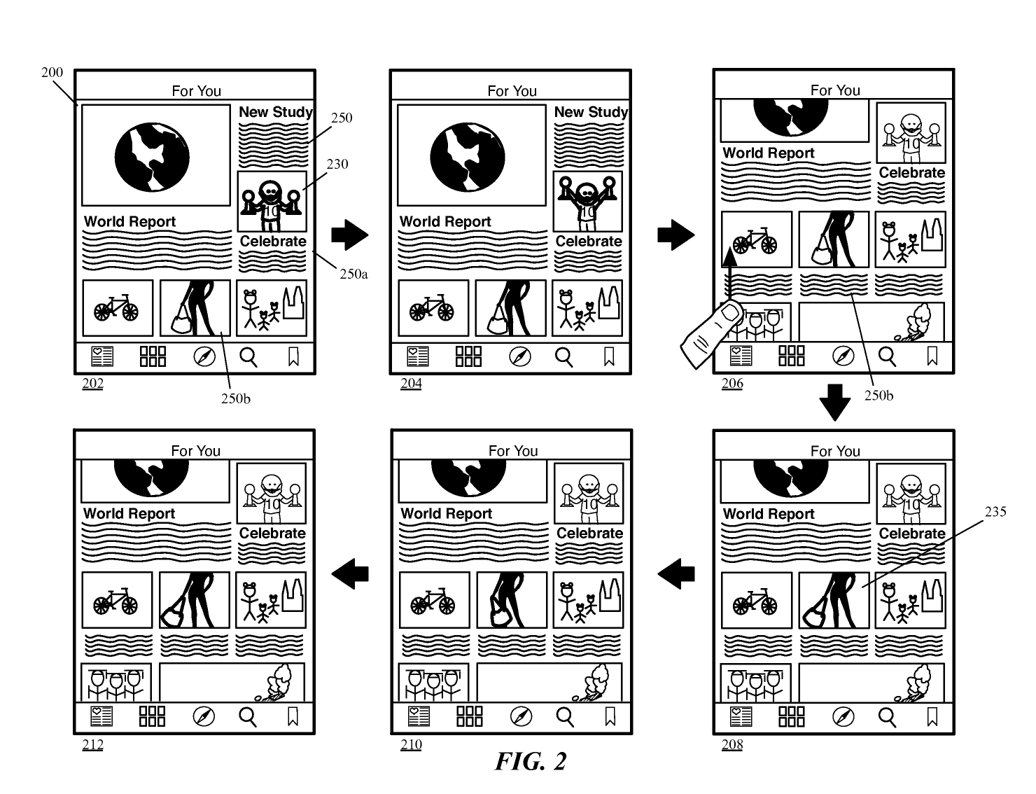

The process 100 is explained by reference to several examples that are illustrated in FIGS. 2-5. These examples illustrate how a content viewer that executes on a mobile device (such as a tablet or smartphone), selects cinemagraphs for display on a variety of pages that it generates. These pages include (1) publisher selection pages that identify several content publishers (article publisher pages, webpage publisher pages, blog publisher pages, etc.), (2) feed pages that provide document summaries for one or more content publishers, and (3) document presentation pages that present published documents (e.g., articles, webpages, blog pages, etc.). Although these examples show the content viewer executing on a mobile device, one of ordinary skill will realize that in other embodiments, this application executes on other devices (e.g., on a computer, laptop, streaming media player, etc.).

In some embodiments, the process 100 starts each time the application produces a document (e.g., page) with multiple candidate cinemagraphs for display. In operations 105-120, the process 100 examines several selection parameters and identifies several candidate cinemagraph presentations based on these selection parameters. Next, at 125, the process selects one or more cinemagraphs to play from the pool of candidate cinemagraphs. In some embodiments, the process 100 does not make its cinemagraph selection based on all of the examined parameters but rather based on only a subset (e.g., one or more) of these parameters. Accordingly, for these embodiments, each examined parameter (identified at 105, 110, 115, or 120) is collectively described as an exemplary parameter that the cinemagraph selection process of some embodiments can use individually or in combination with other parameters to guide its dynamic selection of the cinemagraphs. One of ordinary will realize that a cinemagraph-selection process only needs to examine those parameters that it uses to identify the cinemagraphs that it should select.

At 105, the process identifies the region of focus in the document that it is presenting and identifies one or more candidate cinemagraphs based on the identified focus region. In some embodiments, the process selects the cinemagraphs to present by presenting one or more cinemagraphs on the document that have a particular positional relationship with the identified focus region (e.g., are within or near the focus region). FIG. 2 illustrates an example of selecting a cinemagraph based on the region of focus. In this example, the focus region is the center of the output display that the content viewer generates. In some embodiments, the output display center is assumed to be initial focus location of the user.

In the example of FIG. 2, the content viewer displays a feed page 200 that provides multiple summary panes 250 that summarize multiple articles. Each summary pane has a text component that provides a title and an excerpt for a document. Some of the panes also have an image component (also called image section) that provides an image for the document. The image component of some or all of the panes can switch between displaying a static image and playing a cinemagraph presentation. In some embodiments, the image in the image section of a summary pane can be provided by a cinemagraph object that can operate in either a static mode to display a static still image or in a playback mode to display a cinemagraph presentation.

The example illustrated in FIG. 2 is illustrated in six operational stages 202-212 of the content viewer. The first two stages 202 and 204 show the image component of an article summary pane 250a displaying a cinemagraph presentation 230. This presentation shows a man repeatedly lifting two trophies. In this example, the cinemagraph of the summary pane 250a is selected because of the panes with the cinemagraphs, this pane 250a is the closest to the focus region, which is assumed to be the center of the viewer's output display in this example.

The third stage 206 shows the user scrolling the output display through a touch input on the touch-sensitive display screen of the mobile device. The third stage 206 also shows the cinemagraph presentation of the pane 250a stopping once the scrolling operation begins. As further described below, a cinemagraph presentation in some embodiments can continue during a scroll operation. A scroll operation in some embodiments can also cause a cinemagraph presentation to start.

After the scroll operation, the article summary pane 250b is at the center of the viewer's output display, as shown by the fourth stage 208. A cinemagraph object provides the image for this pane's image section. Hence, as this pane is now within the focus region, the viewer directs this cinemagraph object to starts to display its cinemagraph presentation. The fourth, fifth and sixth stages 208-212 illustrate this cinemagraph presentation 235. As shown, this presentation shows a woman standing still and holding a bag that swings from side to side. In its static mode, the cinemagraph object of the pane 250b just shows one static image of the woman and the bag. In this static image, the bag does not swing, as shown in the first and second stages 202 and 204.

In the example illustrated in FIG. 2, the region of focus is the center of the generated output display. In other embodiments, the focus region might be defined as other regions in the generated output display. For instance, to draw the user's attention to other parts of the output display, some embodiments define the focus region to be one or more of the four corners of the output display. In these cases, a focus region is not necessarily a region that the user will initially examine, but rather is a region to which the user's attention is directed to by the viewer's operation.

After identifying (at 105) focus region within the document being presented, the process identifies (at 110) any new cinemagraph for the document. In some cases, the presented document can have multiple candidate cinemagraphs that are added to the document at different times, or that are updated at different times. Accordingly, the process 100 in some embodiments biases its cinemagraph selection towards newer cinemagraphs as these would be less likely to have been seen by the user and hence would make the document presentation more visually stimulating.

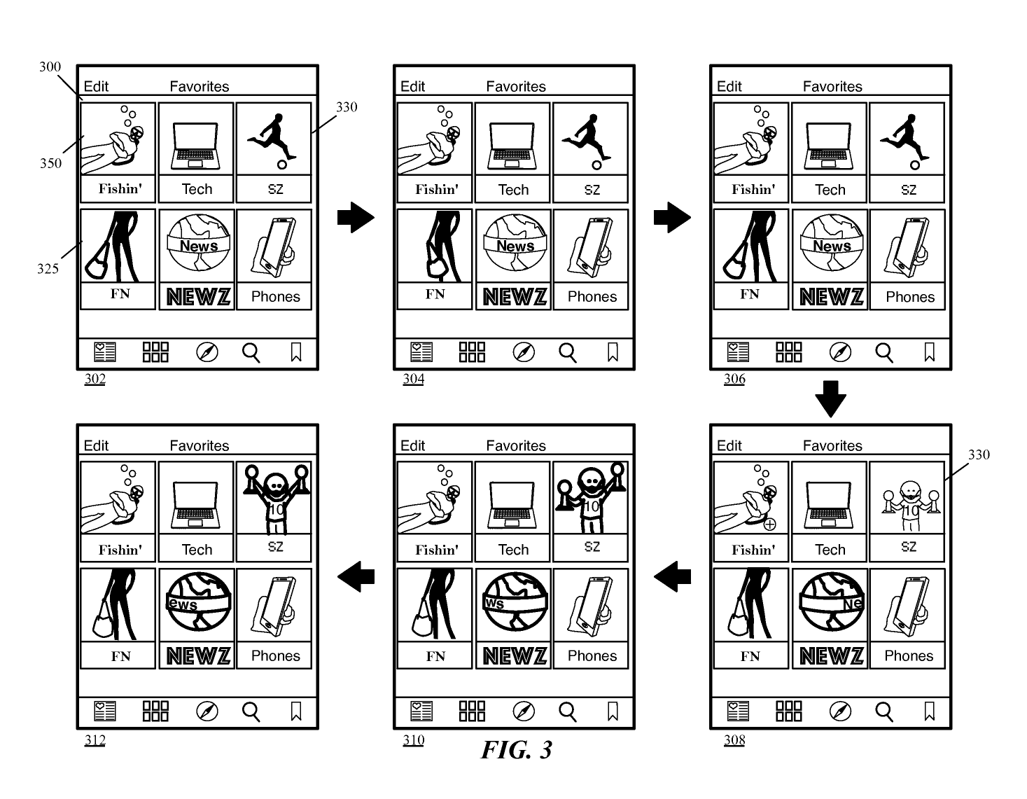

FIG. 3 illustrates an example of selecting a cinemagraph based on when it was added as a candidate cinemagraph for a document. This example illustrates a publisher selection page 300 of a content viewer of some embodiments. On this page, the content viewer illustrates multiple selectable user interface (UI) items 350, each of which identifies one publisher. Selection of a publisher's UI item 350 in some embodiments directs the content viewer to present a feed page that illustrates various document summaries (e.g., article summaries) for various documents (e.g., articles) published by the publisher.

The selection page 300 in some embodiments lists not only publishers but also lists categories (e.g., content topics) and/or brands (e.g., company names, product names, etc.). Selection of a UI item associated with a category or brand directs the content viewer to present a feed page that includes various document summaries for various documents, which relate to the category or brand and which are published by one or more publishers. The discussion below refers to publisher selection pages and publisher feed pages. However, this discussion is equally applicable to selection pages that list categories and brands, and to category feed pages and brand feed pages.

Each publisher's UI item includes (1) a text component that specifies the publisher name and/or logo and (2) an image component that presents an image from one of the documents published by the publisher. The image component of some or all of the publishers can switch between displaying a static image and playing a cinemagraph presentation. In some embodiments, a cinemagraph object from one of the published documents of the publisher provides the image(s) for display in the publisher UI item's image component. This cinemagraph object can operate in either a static mode to display a static still image or in a playback mode to display a cinemagraph presentation (e.g., to display a sequence of images).

The example illustrated in FIG. 3 is illustrated in six operational stages 302-312 of the content viewer. The first three stages 302, 304 and 306 show the image component 325 of one publisher (called FN for Fashion News) displaying a cinemagraph presentation that shows a woman standing still and holding a bag that swings from side to side. These stages also show the image component 330 of another publisher (called SZ for Sport Zone) displaying a still image of a player kicking a soccer ball.

The fourth stage 308 shows the image component 330 of Sport Zone now showing a new image. This image corresponds to a new story published by Sport Zone. Accordingly, to draw attention to this new story, the content viewer (1) directs the cinemagraph object that produces the display for the image component 325 of Fashion News to stop its cinemagraph presentation and instead display a static still image of the woman holding her bag, and (2) directs the cinemagraph object that produces the display for the image component 330 of Sport Zone to display its cinemagraph presentation, as shown in the fifth and sixth stages 310 and 312. This presentation shows a man repeatedly lifting two trophies.

The approach illustrated in FIG. 3 is used in some embodiments to select cinemagraphs on other pages that the content viewer presents. For instance, when multiple candidate cinemagraphs are available on a feed page, the content viewer of some embodiments selects the cinemagraphs that are for the document summaries that have been more recently added or updated to the feed page. Similarly, for a document (e.g., a webpage or blog page) that has multiple sections that are added at different times, the content viewer of some embodiments selects the cinemagraphs for the newer sections over the cinemagraphs for the older sections.

Alternatively, the content viewer of other embodiments may preferentially display the cinemagraphs of older document summaries or document sections that have not been previously viewed to draw a user's attention to these summaries or sections. Similarly, on a publisher selection page, the content viewer of some embodiments may select cinemagraphs for the document publishers that have not been selected or have not been recently selected by the user over the cinemagraphs for the other publishers. It should also be noted that while several examples described above and below refer to publishers of written materials, the publishers in some embodiments may include, or may only include, publishers of video or other visual content (e.g., TV channels, streaming video channels, etc.).

After identifying (at 110) any new cinemagraph for the document, the process identifies (at 115) user-specified preferences and/or user-detected preferences and identifies (at 115) one or more candidate cinemagraphs based on the identified user preferences. In some embodiments, the process 100 in some embodiments selects the cinemagraphs to present based on user specified or detected preferences. In other words, for two users with different preferences, some embodiments present different cinemagraphs from the same group of cinemagraphs. The selection of the cinemagraphs based on user-defined preferences and/or user-detected preferences allows the content viewer of some embodiments to present cinemagraphs to the user that are for documents, document summaries and/or document sources that the user will find more interesting.

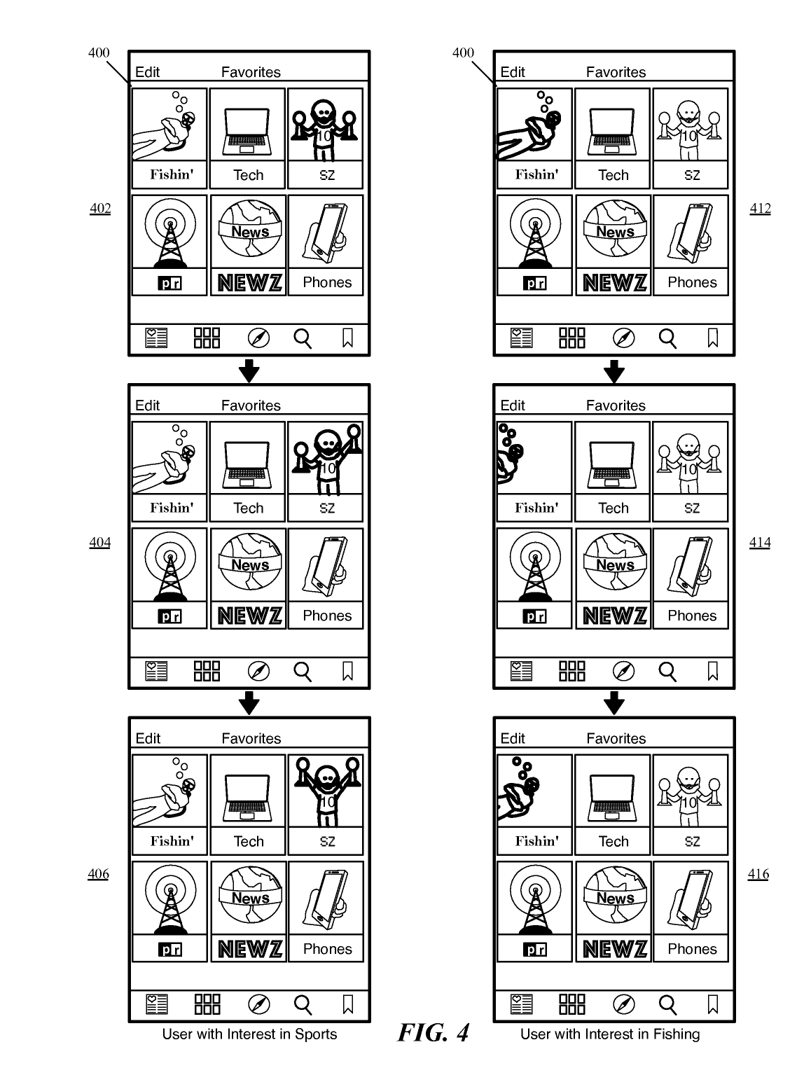

FIG. 4 presents an example that illustrates displaying cinemagraphs based on user-specified or user-detected preferences. This figure illustrates the same publisher selection page 400 play two different cinemagraphs of two different publishers for two users that have different preferences. Two different sets of operational stages 402-406 and 412-416 of the content viewer are presented in two columns. The operational stages 402-406 of the left column 400 show the content viewer presenting a cinemagraph for Sports Zone for a first user that has an interest in sports news. The operational stages 412-416 of the right column show the content viewer presenting a cinemagraph for a fishing magazine (called Fishin') for a second user that has an interest in fishing.

In some embodiments, the content viewer provides one or more controls that allow the user to specify his content preferences. For instance, in some embodiments, the content viewer has an initialization process that allows the user to specify the types of publishers and/or new stories that interest him. Also, in some embodiments, the content viewer detects the user's preference by keeping track of the document and/or document sources that the user has previously selected for viewing. To preserve the user's privacy, some of these embodiments do not store the document and/or document sources that the user selects, but rather use the user's selection to maintain metrics that quantify the user's preferences. For instance, each time the user selects a document, the content viewer in some embodiments (1) identifies the document's type based on the document's metadata or content, and (2) based on the identified document type, adjusts one or more metric values associated with one or more document categories to account for the selection of the document.

Similarly, some embodiments adjust document type metric values when a user selects a document source that is associated with one or more particular categories of documents. In some embodiments, document categories are topical categories that are used to categorize articles, article publishers, webpages, web publishers, blog pages, blog publishers, etc. The topical categories in some embodiments include fashion, technology, sports, entertainment, global politics, regional politics (e.g., U.S. politics, European politics, etc.), brands, etc. Under this approach, the content viewer in some embodiments generates a profile for a user based on the user's selection of documents (e.g., articles) and/or document sources (e.g., electronic newspapers or magazines) over a time duration.

In some embodiments, the user's profile is expressed in terms of a set of category metric values, such as topical categories that express the user's interests in various content types. For instance, for fashion, technology and sports categories, one user's profile might specify metric values of 5, 2, and 1, while another user's profile might specify metric values of 1, 2, and 3, where the metric values are expressed on a scale of 1 to 5, with 1 being the highest metric value. In some embodiments, the user profile is maintained on the device that displays the document, while in other embodiments, the user profile is maintained on a server that distributes the document to one or more devices. Also, some embodiments generate a particular user's profile not just on the particular user's activities, but also on the activities of other users associated with the particular user (e.g., users that are part of the same entity, or part of an online community, etc.). For instance, some embodiments define a user's profile based on content that the user's friends have “liked” online.

Instead of, or in addition to, selecting cinemagraphs based on user preferences, the process 100 dynamically selects cinemagraphs to present based on publisher preferences. Accordingly, at 120, the process 100 identifies publisher specified preferences for the document that the process is currently presenting, and identifies one or more candidate cinemagraphs based on publisher specified preferences. In some embodiments, the publisher-specified preferences are defined with respect to the users that view the document. As such, to identify the publisher specified preferences at 120, the process 100 also accounts for the attributes (e.g., age, sex, location, income, etc.) of the user that is viewing the document.

More specifically, in some embodiments, article publishers express a preference for the type of users that are a target audience for their articles and for the advertisements that are contained in their articles. For such cases, the content viewer of some embodiments preferentially selects and displays the cinemagraphs for the different users by comparing the user profiles to the publisher expressed preferences. In some embodiments, the content viewer accounts for advertising fees and/or other incentives provided by the publishers to preferentially display their cinemagraphs to one or more target group of users. In some embodiments, the publishers can request preferential cinemagraph displays (over content from other publishers) for all users, and not just certain target audience groups.

After identifying the various parameters at 105-120, and various candidate cinemagraphs based on these parameters, the process 100 selects (at 125) one or more cinemagraphs to play from the pool of candidate cinemagraphs. The process 100 uses different heuristics in different embodiments to select the cinemagraphs for display based on the identified parameters. In some embodiments, the process selects the cinemagraphs based on a set of rules that defines an order of precedence among the cinemagraphs that are the highest-ranking cinemagraphs for some or all of the various identified parameters. For instance, in some embodiments, the rule set might have a rule that requires a new cinemagraph that is associated with a user preferred topic or a publisher to be selected over all other cinemagraphs so long as none of the other cinemagraphs satisfies the same criteria (i.e., so long as no other cinemagraph is a new cinemagraph that is associated with a user preferred topic or publisher). To implement this selection process, the process 100 in some embodiments selects for each identified parameter (i.e., each parameter identified at 105-120), one cinemagraph that is the best cinemagraph to choose based on that parameter. At 125, the process 100 uses its rule set to select one or more cinemagraphs from the pool of identified best cinemagraphs.

Instead of using a rule-based approach, the process 100 uses (at 125) a weighted-computational approach in other embodiments to select one or more cinemagraphs from the pool of candidate cinemagraphs. For instance, for each of the parameters examined at 105-120, the process identifies one or more cinemagraphs as candidate cinemagraphs and assigns a score for each identified cinemagraph for the examined parameter. At 125, the process (1) computes for each identified candidate cinemagraph, a weighted aggregate value (e.g., a weight sum) based on the scores and weight values assigned to the different parameters, and (2) selects one or more cinemagraphs for display concurrently or successively based on the computed aggregate values. Equation A below provides an example of an aggregated value V that is computed for a candidate cinemagraph by the weighted computation approach of some embodiments.

V=w₁S₁+w₂S₂+w₃S₃+w₄S₄+w₅S₅ (A)

In this equation, the w variables are weight values, the S variables are the scores, and the subscript are the examined parameters (e.g. the parameters examined at 105-120) that resulted in the score S for the cinemagraph. In some embodiments, a cinemagraph that is selected for a first parameter and has an associated score for the first parameter, might not be selected and scored for a second parameter. In such case, a score of 0 will be used assigned to the cinemagraph for the second parameter. As mentioned above, the process 100 in some embodiments does not make its cinemagraph selection based on all of the identified parameters but rather based on only a subset (e.g., one or more) of these identified parameters. Hence, in these embodiments, the cinemagraph-selection process only needs to identify those parameters that it uses to identify the cinemagraphs that it should select.

After selecting (at 125) one or more cinemagraphs to play from the pool of candidate cinemagraphs, the process 100 plays the selected cinemagraphs. In some embodiments, the process can play more than one cinemagraph presentations concurrently. In other embodiments, the process 100 only plays one cinemagraph presentation at any given time.

After 125, the process 100 determines (at 130) whether it should modify the cinemagraph presentation(s). In some embodiments, the process modifies a cinemagraph presentation based on user or device input, as further described below. Also, in some embodiments, the process 100 changes the cinemagraphs that it presents to provide different sets of one or more cinemagraphs at different time intervals, in order to keep its document presentation fresh and interesting. Accordingly, when the process determines that it should modify its cinemagraph presentation(s), it transitions to 135, where it modifies the cinemagraph presentation(s) and then returns to 130.

In some embodiments, each time the process returns to 130, it performs one or more of the operations 105-120 in order to re-assess the parameters that it uses to select cinemagraphs. In other embodiments, the process reassesses (at 130) one or more of these parameters at particular intervals (e.g., once every minute, every 15 minutes, every hour, every 6 hours, every 24 hours, etc.). After returning to 105-120 to re-assess the parameters that it uses to select cinemagraphs, the process 100 in some embodiments modifies these parameters or assesses (e.g., scores) these parameters differently in order to obtain different results. For example, after highly scoring a cinemagraph that is in the center of the display output, the process in some embodiments lowers the score of this cinemagraph when it previously selected it or changes the definition of the focus region, in order to facilitate its selection of another cinemagraph.

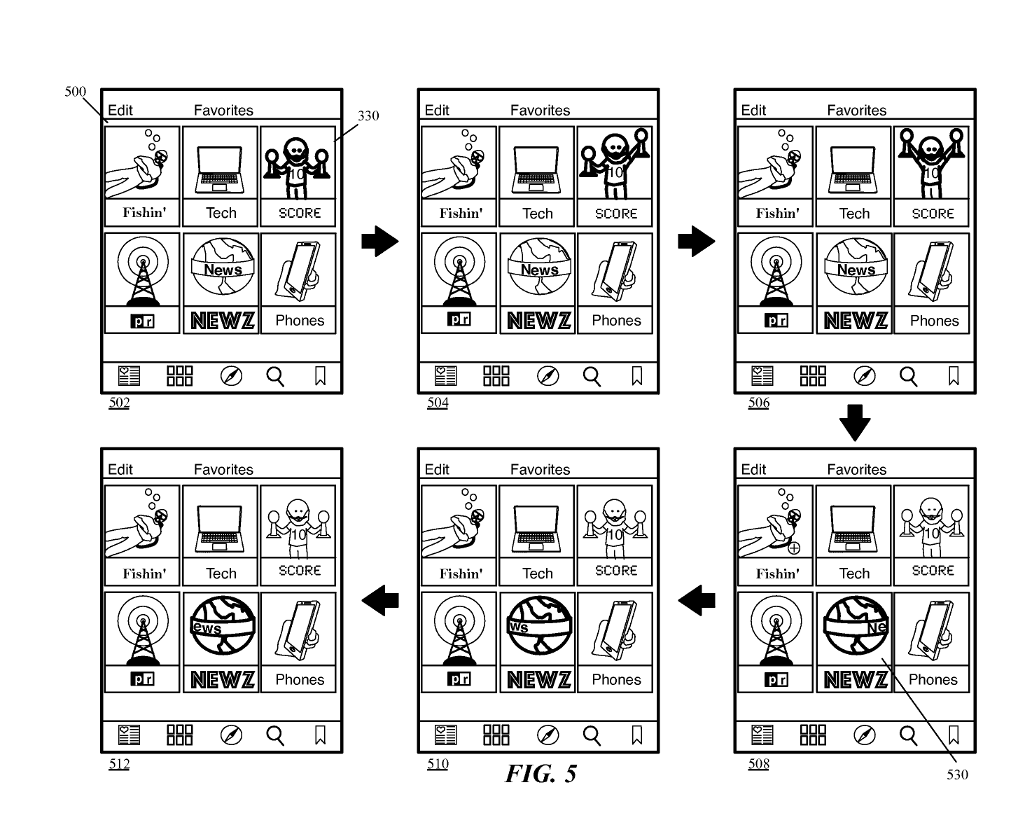

FIG. 5 illustrates an example of the process 100 changing the cinemagraph presentations in order to keep its document presentation fresh and interesting. Specifically, in six operational stages 502-512 of the content viewer of some embodiments, this figure illustrates the content viewer switching between two cinemagraph presentations on a publisher selection page 500. The first three stages 502-506 show the image component 330 of one publisher (Sport Zone) displaying a cinemagraph presentation that shows a man repeatedly lifting two trophies. No other cinemagraphs are played in these stages.

The last three stages 508-512 show the image component 530 of another publisher (Newz) displaying another cinemagraph presentation, which shows the word “News” moving about the equator of a still image of the globe. In these stages, no other cinemagraph is played. As such, the cinemagraph presentation of the man lifting the two trophies has been replaced by a still image of the man in the image component 330. In the example illustrated in FIG. 5, the content viewer iteratively cycles through its candidate cinemagraphs in order to keep the publisher selection page fresh and visually stimulating.

When the process 100 determines (at 130) that it should not modify its cinemagraph presentation(s), it determines (at 140) whether it should stop its cinemagraph presentation(s). The process 100 stops its cinemagraph presentations for a document when it stops its presentation of the document. In some embodiments, the process 100 also stops it cinemagraph presentations when it determines (at 140) that it has provided a sufficient number of cinemagraphs or it has provided cinemagraphs for a sufficient duration of time. In these or other embodiments, the process may stop its cinemagraph presentations based on other criteria. If the process determines (at 140) that it should end the cinemagraph presentations, it ends. Otherwise, the process returns to 130.

From multiple available candidate cinemagraphs for a document, the process 100 advantageously selects the cinemagraph(s) to present on the document without receiving any user interface input to select a candidate cinemagraph presentation or to indicate a preference for a candidate cinemagraph presentation. This process automatically selects one candidate cinemagraph presentation based on one or more of the above-mentioned selection criteria. More specifically, this process selects the cinemagraph(s) without receiving any user interface input to indicate a preference for the candidate cinemagraph presentation after the document is displayed.

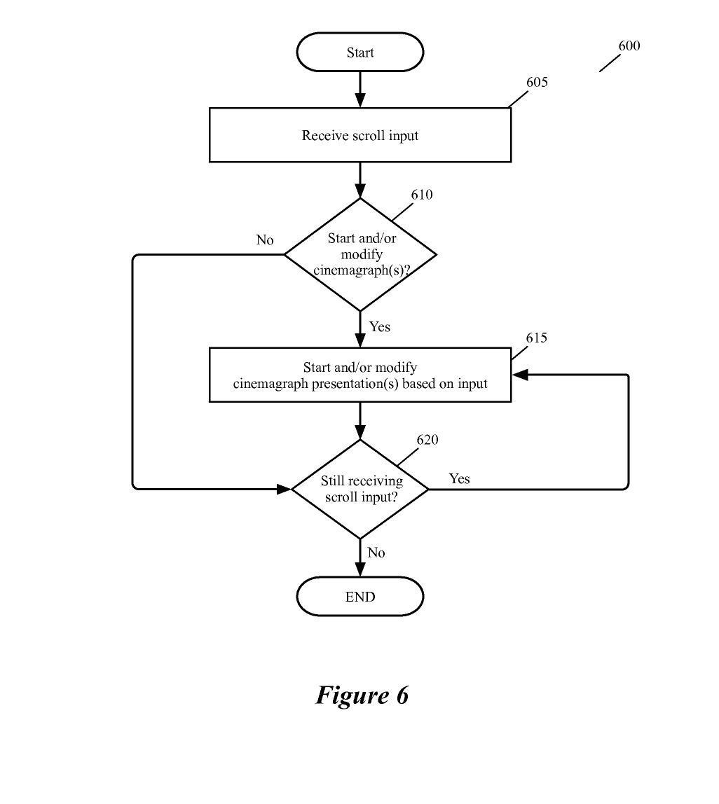

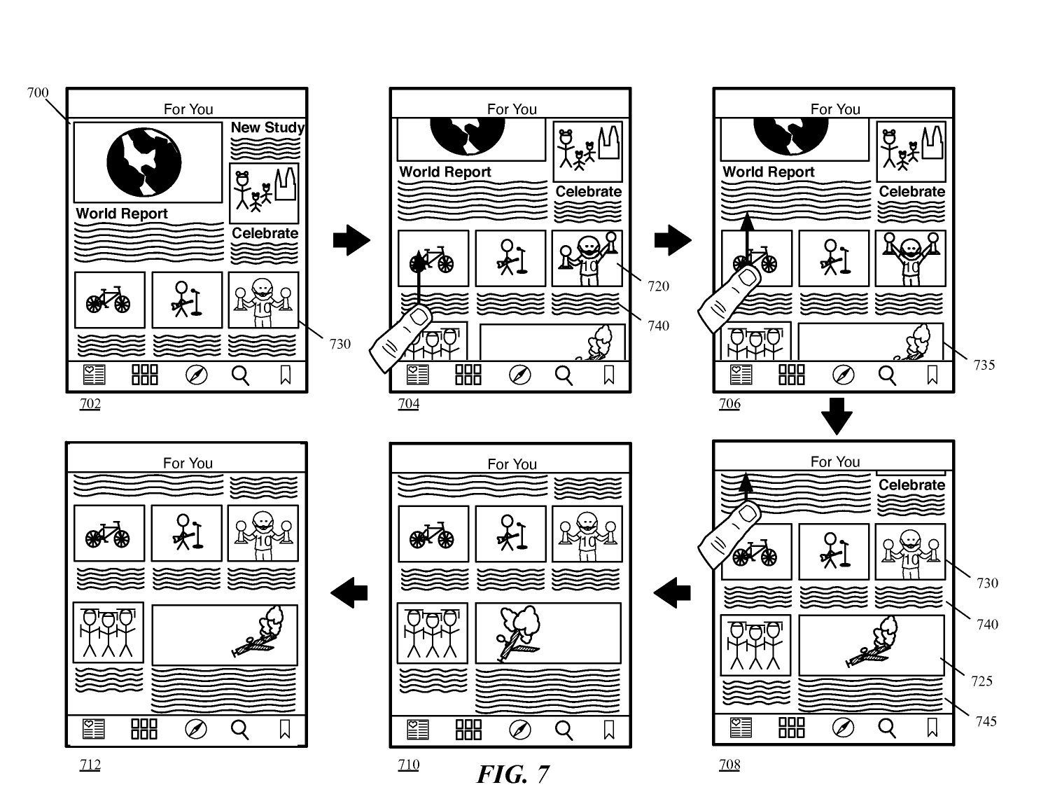

Some embodiments dynamically start a cinemagraph presentation, or dynamically modify a cinemagraph presentation, on a document based on input that is received on the device that presents the document. FIG. 6 illustrates a process 600 that dynamically starts or modifies a cinemagraph presentation based on scroll input received by the device that displays the cinemagraph presentation. This process will be explained by reference to FIG. 7, which illustrates an example of stopping one cinemagraph presentation while starting another cinemagraph presentation in response to scroll input. The content viewer of some embodiments performs the process 600, while in other embodiments, other types of applications (e.g., browsers, browser-accessible server applications, word processing applications, presentation applications, etc.) perform this process.

As shown, the process starts when scroll input is received (at 605) from one or more input controllers of the device (e.g., the mobile device) that executes the process (e.g., executes the content viewer). Examples of such input controllers include touch input controller from the touch-sensitive interface of the mobile device, cursor controller for receiving input from a cursor pointing device (e.g., a mouse, a trackpad, etc.), etc. In some embodiments, the application that performs the process 600, receives the scroll input through the operating system and/or framework of the mobile device.

At 610, the process determines whether it should start or modify one or more cinemagraph presentations based on the received input. If not, the process transitions to 620, which will be explained below. Otherwise, based on the received input, the process (at 615) starts or modifies one or more cinemagraph presentations that it identifies at 610. After 615, the process transitions to 620. At 620, the process determines whether it is still receiving scroll input. If so, it transitions back to 615 to modify the cinemagraph presentation if needed. Otherwise, the process ends.

FIG. 7 illustrates one example of starting and modifying cinemagraph presentations based on scroll input on a mobile device that executes a content viewer. This figure illustrates six operational stages 702-712 of the content viewer of some embodiments. Each of these stages shows a displayed document feed page 700 at various different instances before, during and after the scroll input.

The first operational stage 702 shows the feed page before the scroll input has been received. At this stage, the content viewer is not playing any cinemagraph presentations. The second, third and fourth operational stages 704-708 show a scroll input that is received through the touch interface of the mobile device. The second and third stages 704 and 706 show the scroll operation starting a cinemagraph presentation 720 for one document summary 740 on the feed page. This cinemagraph presentation shows a man repeatedly lifting two trophies. Before the scroll operation, the document summary's image component 730 presents a still image of the man holding the two trophies, as shown in the first stage 702.

The fourth stage 708 shows the content viewer stopping the cinemagraph presentation 720 while starting another cinemagraph presentation 725. In this example, the content viewer stops the first cinemagraph presentation 720 and starts the new presentation in order to highlight different document summaries as the user scrolls across the page. In some embodiments, the highlighted document summaries are the document summaries that meet one or more of the parameters that were described above by references to operations 105-120 (e.g., are document summaries that are in the focus region, that are new, that meet user-specified preferences, that meet publisher specified preferences, etc.).

The fourth stage 708 shows that once the cinemagraph presentation 720 stops, the image component 730 of the document summary 740 presents the still image of the man holding the two trophies. This stage also shows the image component 735 of the document summary 745 playing the cinemagraph presentation 725, which shows a plane on fire and descending. Before the scroll operation, the image component 735 presents a still image of the plane on fire, as shown in the second and third stages 704 and 706.

The fifth stage 710 shows the cinemagraph presentation 725 continuing for a time period after the scroll operation has ended. The sixth stage 712 shows the feed page once the cinemagraph presentation 725 has ended after the expiration of the time period. In this stage, the content viewer is not presenting any cinemagraphs, like the first stage 702 before the scroll input was received. In the example illustrated in FIG. 7, the scroll input started two cinemagraph presentations. In some embodiments, a scroll input (e.g., a scroll input on a touch-sensitive display screen) modifies a cinemagraph presentation that was playing before the scroll input was received. For instance, in some embodiments, the scroll input may speed up or slow down the frame rate at which the cinemagraph presentation is played. This may then make moving objects or other animations in the cinemagraph to appear to move faster or slower.

In some embodiments, the cinemagraph presentation playback speed (e.g., frame rate) is directly or inversely proportional to the scroll input velocity. During the scroll operation, the scroll input can be captured as several discrete scroll operations with several discrete scrolling velocities. Some embodiments define various discrete cinemagraph presentation playback speeds for the some or all of the discrete scrolling velocities.

As mentioned above, some embodiments start or modify cinemagraph presentations based on other types of sensor inputs that are received on the device. Examples of such sensor input include motion input from one or more motion sensors (e.g., accelerometers, gryoscopes, etc.) of the mobile device, voice input from the voice interface of the mobile device, etc. Some of these embodiments perform processes similar to process 600, except that these processes are started after receiving sensor input and start/modify cinemagraph presentations based on the received sensor input.

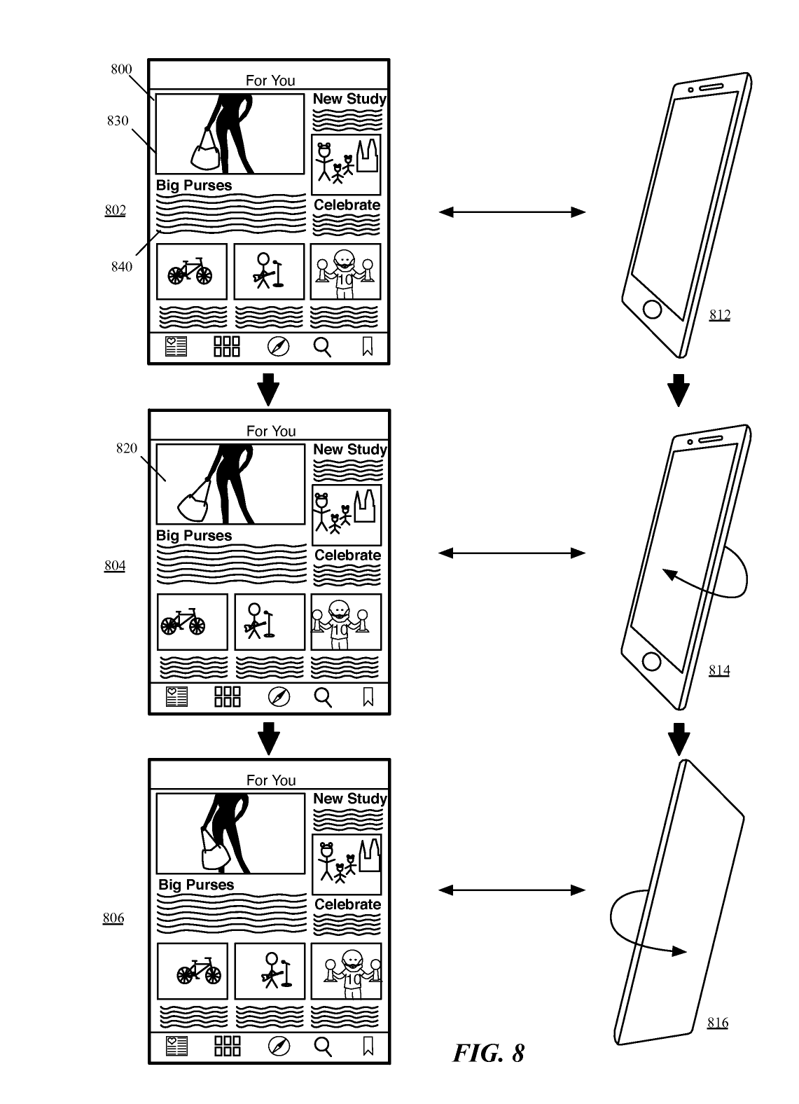

FIG. 8 illustrates an example of starting or modifying a cinemagraph presentation based on motion sensor input. In this example, the motion sensor input detects rotational movements of the device and based on this movement, it can start or modify cinemagraph presentations, according to a process similar to the process 600 of FIG. 6. The motion sensor input in some embodiments comes from an accelerometer and/or a gyroscope of the mobile device.

FIG. 8 illustrates its example in terms of three operational stages 802-806 of the content viewer of some embodiments. As shown, each of these stages corresponds to a particular rotational state 812-816 of the device. Also, each stage shows a displayed document feed page 800 for each of the rotational states.

The first stage 802 shows the feed page before the device starts to be rotates. At this stage, the content viewer is not playing any cinemagraph presentations. The second and third stages 804 and 806 show the feed page after the device starts to rotate. As shown, this rotation starts a cinemagraph presentation 820 for one document summary 840 on a feed page 800. This cinemagraph presentation shows a woman standing still and holding a bag that swings from side to side. Before the scroll operation, the document summary's image component 830 presents a still image of the woman and the bag. In this static image, the bag does not swing, as shown in the first stage 802.

In some embodiments, the cinemagraph presentation playback speed (e.g., frame rate) is directly or inversely proportional to the rotational velocity. When the device is rotating, the rotation can be captured as several discrete rotation operations with several discrete rotation velocities. Some embodiments define various discrete cinemagraph presentation playback speeds for the some or all of the discrete rotational velocities.

In some embodiments, a cinemagraph presentation is started or modified when a certain rotation movement (e.g., a movement that exceeds a threshold angle) of the device is detected based on the output of its motion sensor(s). In some embodiments, a cinemagraph presentation can also be started or modified based on input from other sensors of the mobile device. After starting or modifying a cinemagraph presentation in response to received sensor input, some embodiments terminate the cinemagraph presentation or stop modifying the cinemagraph presentation a time period after the received input ends.

Some embodiments provide novel methods for using cinemagraphs to produce visually stimulating document transitions. In some embodiments, an application (e.g., web browser, document reader, word processing application, presentation program, etc.) provides an animation to visually illustrate the transition from one document to another. When a cinemagraph is being presented on the first document and is part of the content displayed on the second document, some embodiments incorporate the cinemagraph presentation in the animated transition from the first document to the second document.

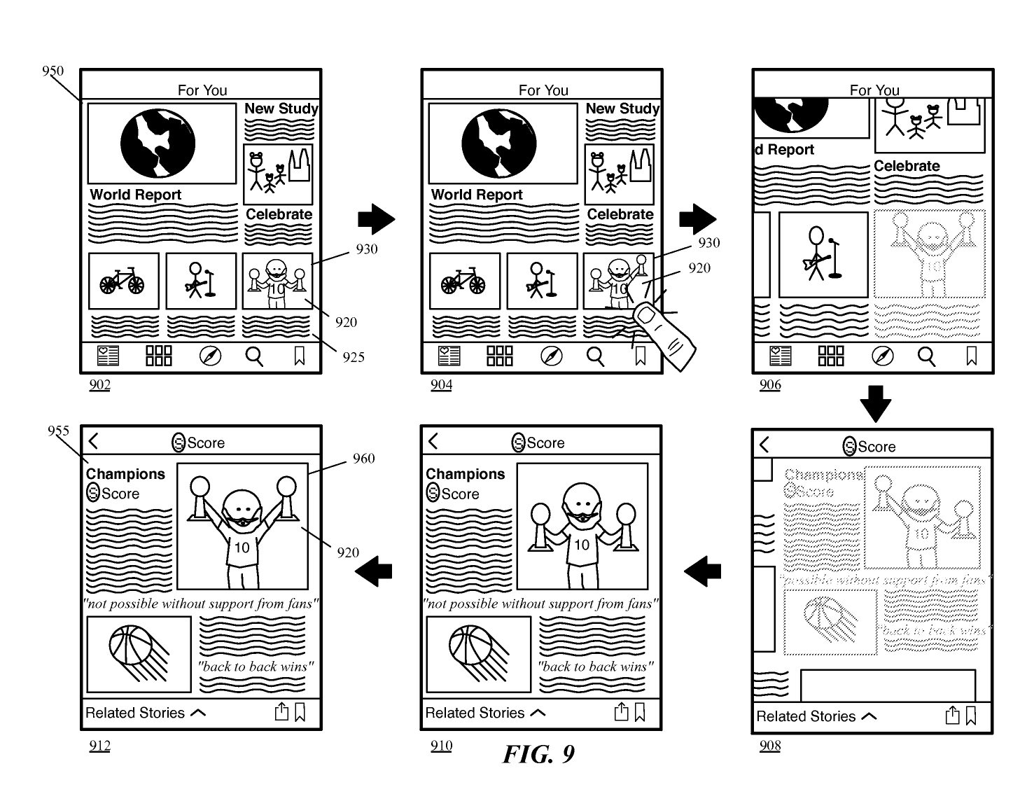

For instance, in some embodiments, the cinemagraph presentation continues to play during the animated transition between two documents but its size is adjusted to account for a larger or smaller space that it occupies on the second document. FIG. 9 illustrates an example that shows a cinemagraph presentation 920 continuing to be displayed during the animated transition between a feed page 950 and an article presentation page 955. This example is illustrated in terms of six operational stages 902-912 of the content viewer of some embodiments.

The first two stages 902 and 904 show the cinemagraph presentation 920 playing in the image component 930 of a document summary 925 on this page. This presentation shows a man repeatedly lifting two trophies. The second stage 904 also shows the document summary 925 being selected. This selection directs the content viewer to switch from the feed page 950 to the article presentation page 955 in order to present the article associated with the document summary 925. The cinemagraph presentation 920 is displayed by an image component 960 on the article presentation page 955, as shown in the fifth and sixth stages 910 and 912.

The space for the cinemagraph presentation is bigger in the article presentation page 955 than it is in the feed page 950 (i.e., as the image component 960 is bigger than the image component 930). Hence, the animated transition between the two pages 950 and 955 shows the cinemagraph presentation growing from its size on page 950 to its size on page 955, as shown by the third, fourth and fifth stages 906-912. These stages also show the cinemagraph presentation 920 playing (i.e., the man repeatedly lifting the trophies) during the animated transition. In this example, the cinemagraph presentation continues in the sixth stage 912 after the transition between the two pages.

In some embodiments, the cinemagraph presentation during the transition from one page to another page is different than the cinemagraph presentation on one or both pages. Also, in some embodiments, a cinemagraph presentation might only play during the animated transition between two pages and not on either page. In addition, in some embodiments, a cinemagraph presentation might play during the animated transition between two pages and on one of the two pages, but not the other page.

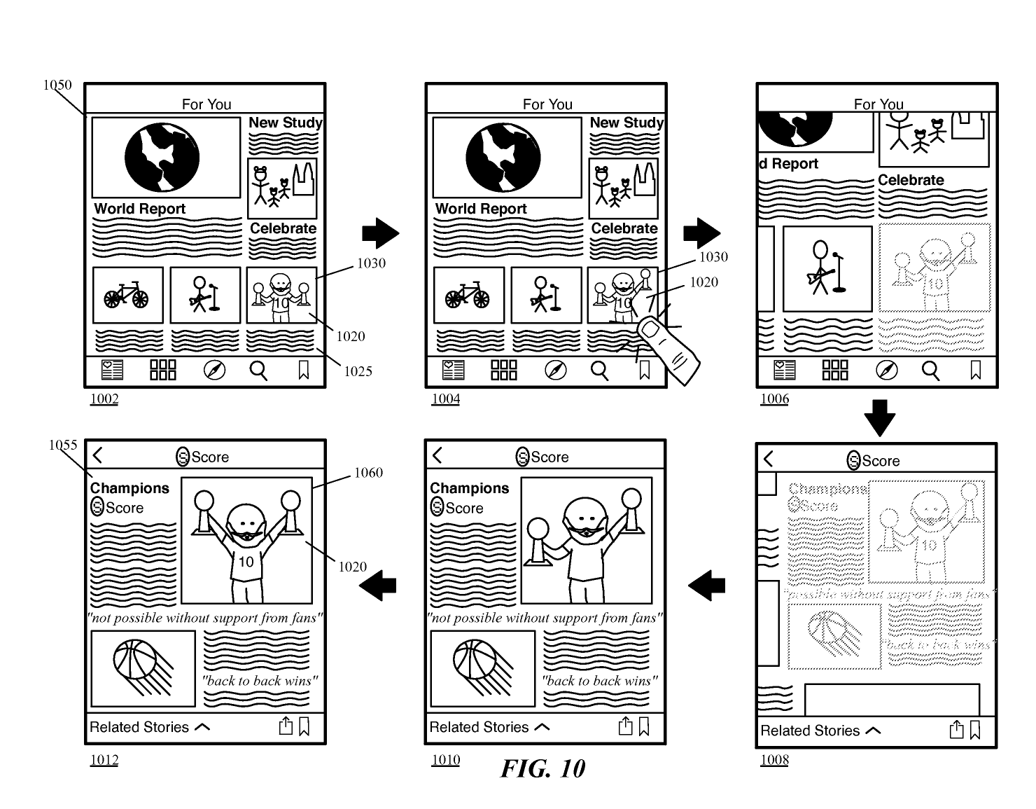

In some embodiments, the cinemagraph presentation stops during a transition from one document to another, but resumes on the second document at the location that it stopped on the first document. FIG. 10 illustrates an example that shows a cinemagraph presentation 1020 (1) stopping during an animated transition between a feed page 1050 and an article presentation page 1055, and (2) resuming on page 1055 at the frame where it stopped on page 1050. This example is illustrated in terms of six operational stages 1002-1012 of the content viewer of some embodiments.

The first two stages 1002 and 1004 show the cinemagraph presentation 1020 playing in the image component 1030 of a document summary 1025 on this page. This presentation shows a man repeatedly lifting two trophies. The second stage 1004 also shows the document summary 1025 being selected. This selection directs the content viewer to switch from the feed page 1050 to the article presentation page 1055 in order to present the article associated with the document summary 1025.

As shown by the third, fourth, and fifth stages 1006-1010, the cinemagraph presentation 1020 freezes during the animated transition between the two pages. In these stages, the cinemagraph presentation displays the same frame as the frame that was displayed during the second stage 1010 when the document summary 1025 was selected. The sixth stage 1012 shows the cinemagraph presentation 1020 starting on the article presentation page 1055 at the next frame after the frame that was displayed in the second stage 1010.

The cinemagraph presentation 1020 is displayed by an image component 1060 on the article presentation page 1055, as shown in the fifth and sixth stages 1010 and 1012. The space for the cinemagraph presentation is bigger in the article presentation page 1055 than it is in the feed page 1050 (i.e., as the image component 1060 is bigger than the image component 1030). Hence, the animated transition between the two pages 1050 and 1055 shows the cinemagraph presentation growing from its size on page 1050 to its size on page 1055, as shown by the third, fourth and fifth stages 1006-1012.

When the cinemagraph presentation appears on first and second documents and the second document can be navigated to and from the first document, the cinemagraph presentation is identical on both pages in some embodiments. In other embodiments, the cinemagraph presentation on one document can differ from the cinemagraph presentation on the other document. For instance, in some embodiments, the cinemagraph presentation on the subsequent second document is more complex (e.g., contains more frames) than the cinemagraph presentation on the previous first document.

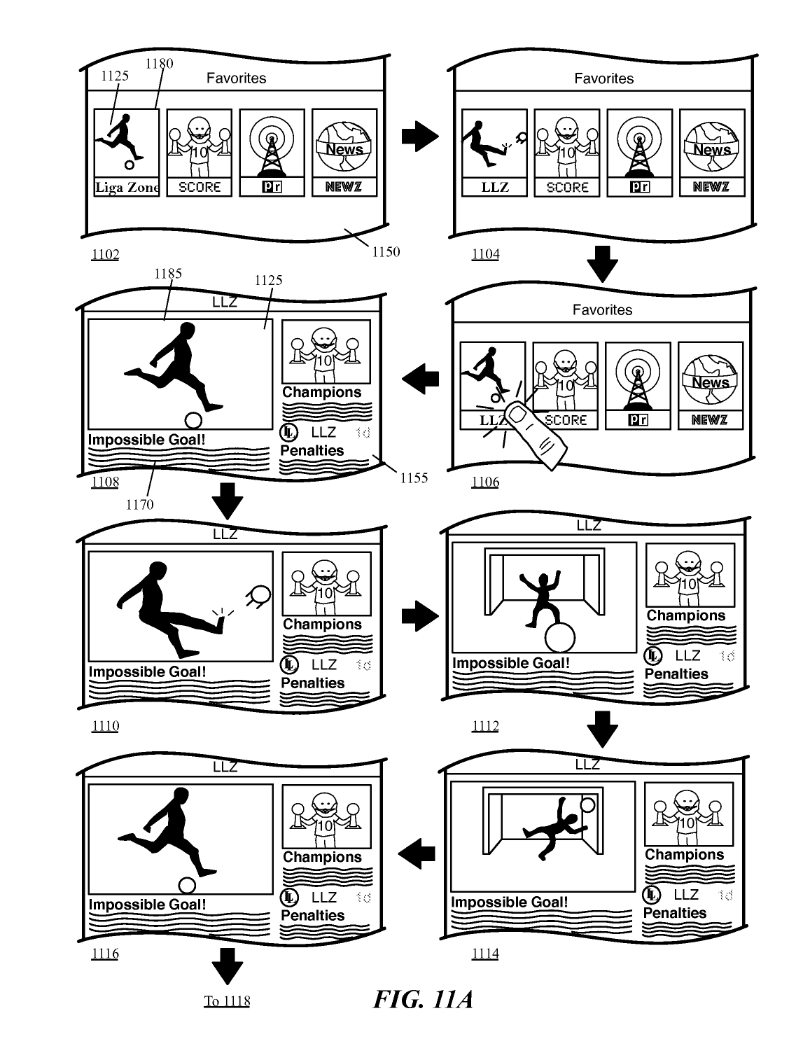

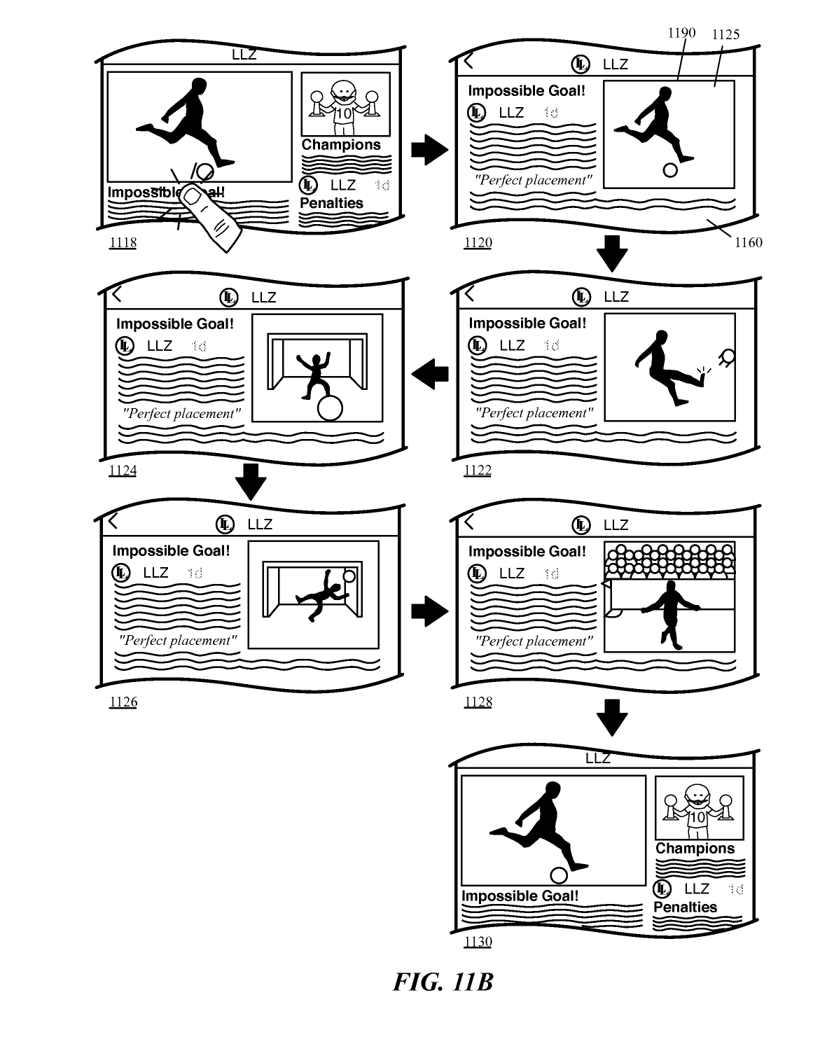

FIGS. 11A and 11B illustrate one example of a cinemagraph presentation 1125 that gets gradually more complex as the content viewer steps through a series of linked documents that are displayed by a mobile device. In this example, the cinemagraph presentation 1125 appears on a publisher selection page 1150, a publisher feed page 1155 and an article presentation page 1160. The publisher selection page 1150 has a link to the publisher feed page 1155, and the publisher feed page 1155 has a link to the article presentation page 1160. In this example, the cinemagraph presentation has X frames on the publisher selection page 1150, Y frames on the publisher feed page 1155, and Z frames on the article presentation page 1160, where X, Y, and Z are integers, X is less than Y, and Y is less than Z.

The example presented in FIGS. 11A and 11B is illustrated in fifteen stages 1102-1130. The first three stages 1102-1106 show the publisher selection page 1150 playing the cinemagraph presentation 1125 in an image section 1180 of the publisher LLZ (La Liga Zone) UI item. This cinemagraph shows a player repeatedly kicking a ball. On this page, the cinemagraph presentation cycles through X frames.

The third stage 1106 shows the user selecting the publisher LLZ by tapping on this publisher's icon on the touch sensitive screen of the mobile device. This icon has an associated link that identifies the publisher feed page 1155. Thus, selection of this icon directs the content viewer to display the feed page 1155, as shown by the fourth stage 1108. This feed page shows summaries of several articles from the publisher LLZ. One of these article summaries is the article summary 1170 that displays the cinemagraph presentation 1125 in its image section 1185. This article summary is for an article entitled “Impossible Goal.”

The fourth-ninth stages 1108-1118 show the publisher feed page 1155 playing the cinemagraph presentation 1125, which now shows the player repeatedly kicking the ball and scoring. On this page, the cinemagraph presentation cycles through Y frames. The ninth stage 1118 shows the user selecting the article summary 1170 by tapping on this summary's icon on the touch sensitive screen of the mobile device. This icon has an associated link that identifies the article presentation page 1160. Thus, selection of this icon directs the content viewer to display the article presentation page 1160, as shown by the tenth stage 1120.

The article presentation page 1160 shows the article entitled “Impossible Goal.” This article includes an image section 1190 in which the cinemagraph presentation 1125 plays. As shown by the tenth-fifth stages 1120-1130, the cinemagraph presentation 1125 now shows the player repeatedly kicking the ball, scoring, and then celebrating. On this page, the cinemagraph presentation cycles through Z frames.

In the approach illustrated in FIGS. 11A and 11B, as the user directs the content viewer to transition from the publisher selection page to the publisher feed page and then to the article presentation page, the cinemagraph presentation becomes a richer presentation because the user's interest in the page associated with the cinemagraph has become clearer. In some embodiments, the first set of X frames is part of the second set of Y frames, which is part of the third set of Z frames. In some of these embodiments, the cinemagraph presentation is just one presentation that cycles through different sets of frames in different situations. In some embodiments, the different sets of frames for the different pages do not have to be overlapping, or do not have smaller sets of frames for some pages that are completely subsumed by larger sets of frames of other pages.

In other embodiments, different cinemagraph presentations are defined for the image sections 1180, 1185 and 1190 of the publisher selection page 1150, the publisher feed page 1155 and the article presentation page 1160. These different cinemagraph presentations can show the same scene or subject matter or show overlapping portions of the same scene or subject matter. In some embodiments, these cinemagraph presentations can include different overlapping or non-overlapping sets of frames, but with no smaller set completely subsumed by a larger set. The overlap between the sets of frames ensures some continuity between the cinemagraph presentations on the different pages.

In some embodiments, different ways can be specified for stepping through the frames of a cinemagraph presentation. For instance, in addition to sequentially displaying these frame, some embodiments allow the frames to be displayed in a reverse order, a random order, or any other desired order (e.g., an order through the even frames or the odd frames, etc.). The frame rate can also be assigned to be different for different cinemagraphs that are candidates for display on the same document. Also, in some embodiments, different frames or different sets of frames of a cinemagraph presentation can be displayed at different frame rates (e.g., some frames can be displayed for M fraction of a second, while other frames are displayed at N fraction of a second). In some embodiments, the frame rate can ascend or descend as the cinemagraph presentation steps through its frames in one cycle. The cinemagraph presentation in some embodiments can have a delay defined at its start, middle or end of the presentation, or between frames. Such a delay would slow down the frame rate at the location for which it is defined in the cinemagraph.

Many of the cinemagraph presentation examples described above show the movement of one or more objects in a scene. Cinemagraphs, however, do not always have to include moving objects. Some embodiments generate cinemagraphs by changing pixel color values in a series of frames that depict a still image of a scene. Some embodiments change the color values by applying one or more special effects to a still image to produce several different frames for the cinemagraph. Some embodiments combine cinemagraphs with other image animation effects, such as parallax effects, or other visual effects.

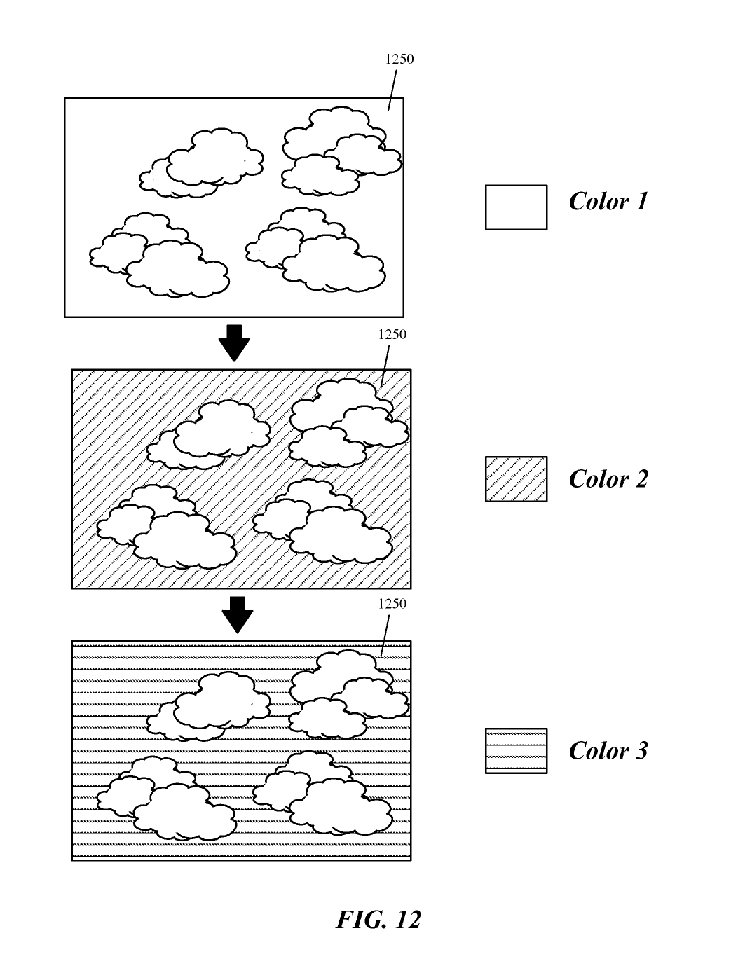

FIG. 12 illustrates an example of a cinemagraph presentation 1250 that achieves its animation by changing pixel color values. This cinemagraph presentation 1250 does not show any object moving. Rather, it shows a still image of a number of clouds, where the color of the background sky repeatedly cycles through a series of color.

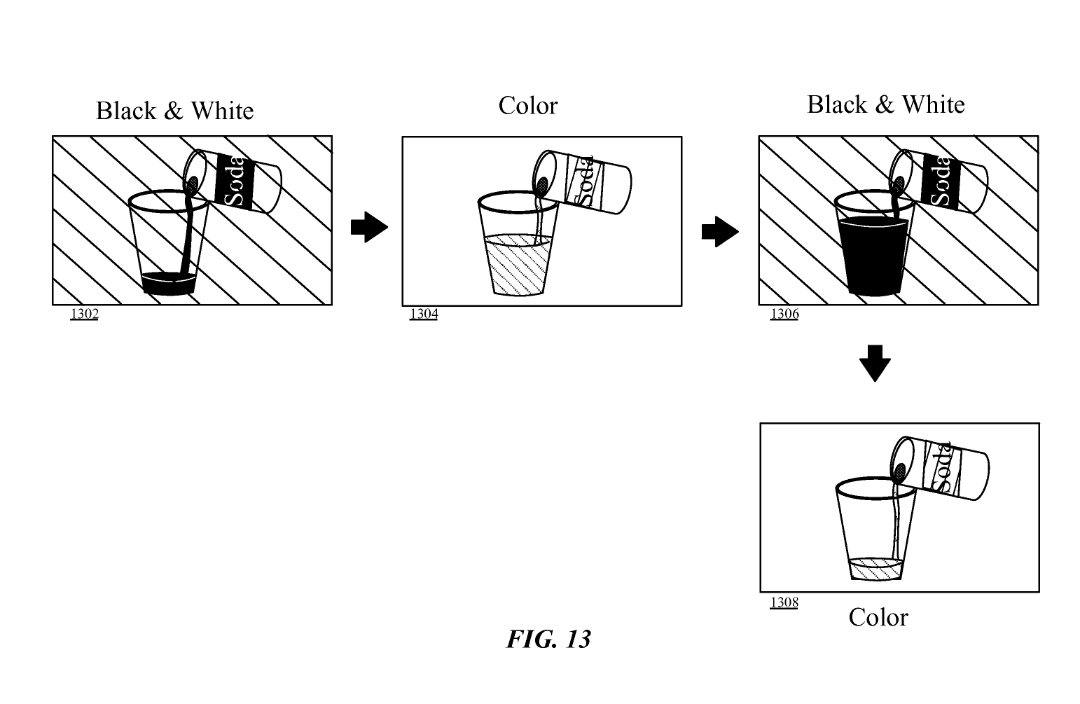

FIG. 13 illustrates another example of a cinemagraph presentation 1350 that achieves its animation by changing pixel color values. However, this cinemagraph's animation also includes an object moving. In four stages 1302-1308, this cinemagraph shows soda being poured into a glass in a still image that cycles through a series of transitions between a monochrome (black and white) presentation and a color presentation. Other than the stream of soda being poured and rising/falling soda in the glass, nothing else in the still image moves.

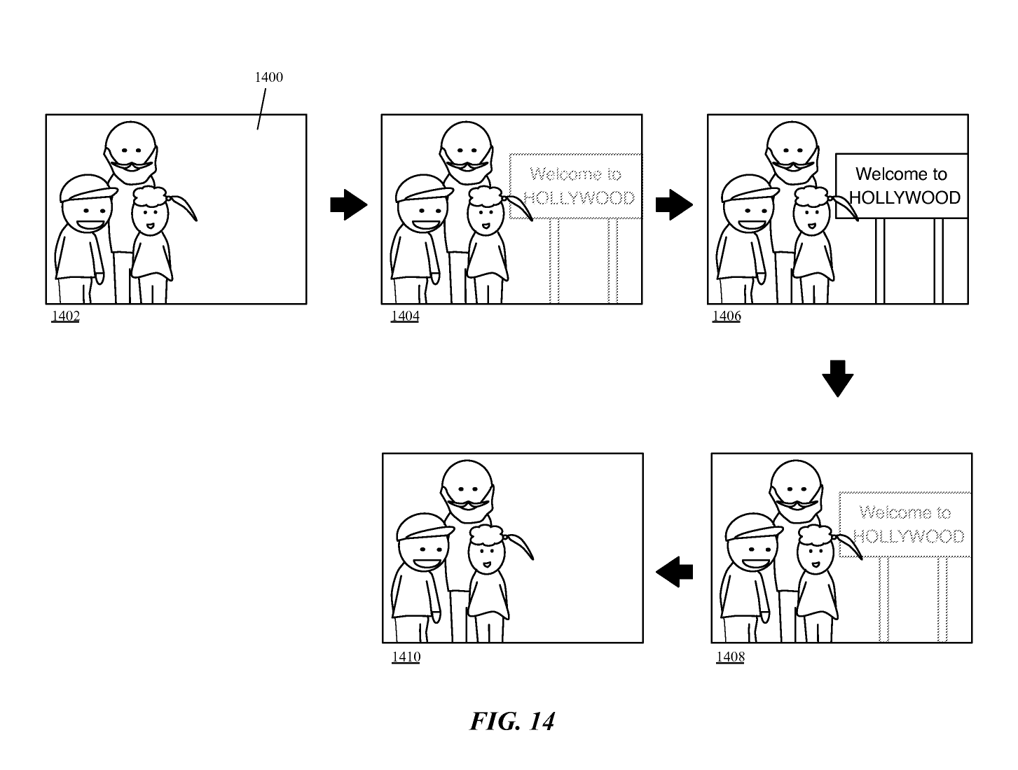

In addition to moving objects and changing pixel color values, some embodiments also generate cinemagraphs by fading in and out objects in a scene. FIG. 14 illustrates an example of such a cinemagraph. In five stages 1402-1410, this figure illustrates a cinemagraph 1400 that shows an image of three people with a sign (saying Welcome to Hollywood) fading in and out of the image.

The cinemagraph presentations of some embodiments include not only visual component but also include an audio component. The audio component can be synchronous with the visual component, or it can be asynchronous. Also, in some embodiments, the visual and audio components can have the same play cycle and duration, or can have different individual play cycles and overall play durations.

Some embodiments also present different cinemagraph presentations in an image section based on different input (e.g., different touch input, multi-touch input, gestural input, etc.) from a user. For example, a single tapping input on an image of a soccer player kicking a ball directs the content viewer to display a cinemagraph that shows a sequence of frames that show the player kicking the ball, while a double tap on the image directs the content viewer to display a cinemagraph that shows a sequence of frames that show the player kicking the ball and scoring a goal.

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

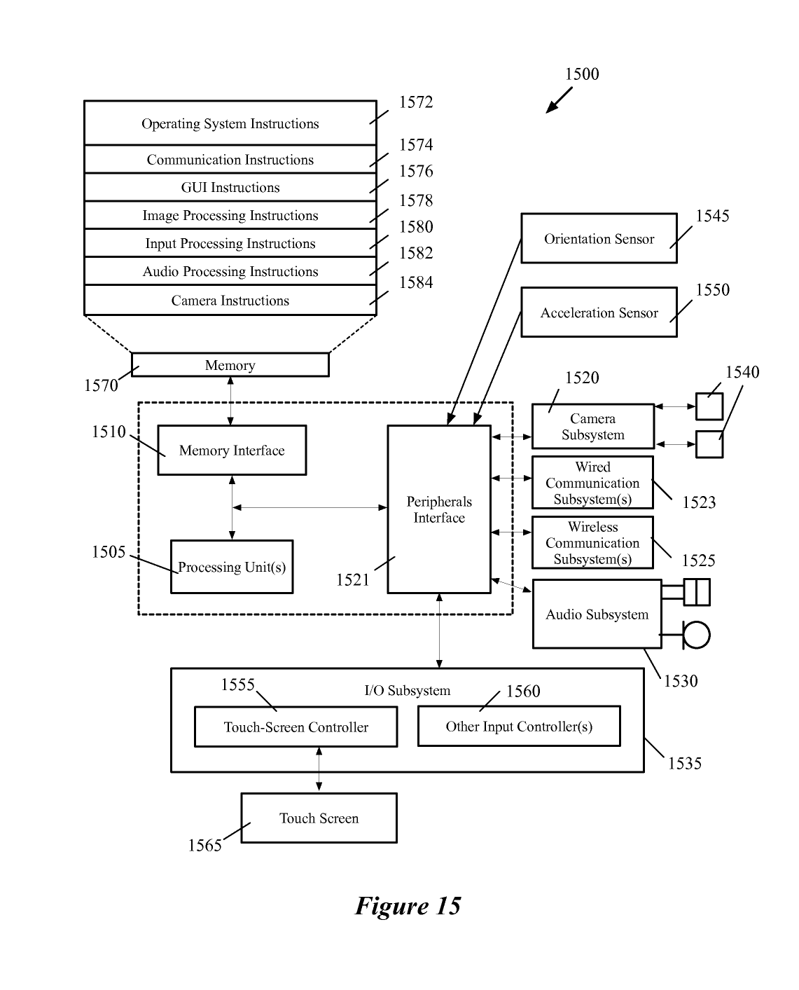

The applications of some embodiments operate on mobile devices, such as smart phones (e.g., iPhones®) and tablets (e.g., iPads®). FIG. 15 is an example of an architecture 1500 of such a mobile computing device. Examples of mobile computing devices include smartphones, tablets, laptops, etc. As shown, the mobile computing device 1500 includes one or more processing units 1505, a memory interface 1510 and a peripherals interface 1515.

The peripherals interface 1515 is coupled to various sensors and subsystems, including a camera subsystem 1520, a wireless communication subsystem(s) 1525, an audio subsystem 1530, an I/O subsystem 1535, etc. The peripherals interface 1515 enables communication between the processing units 1505 and various peripherals. For example, an orientation sensor 1545 (e.g., a gyroscope) and an acceleration sensor 1550 (e.g., an accelerometer) is coupled to the peripherals interface 1515 to facilitate orientation and acceleration functions.

The camera subsystem 1520 is coupled to one or more optical sensors 1540 (e.g., a charged coupled device (CCD) optical sensor, a complementary metal-oxide-semiconductor (CMOS) optical sensor, etc.). The camera subsystem 1520 coupled with the optical sensors 1540 facilitates camera functions, such as image and/or video data capturing. The wireless communication subsystem 1525 serves to facilitate communication functions. In some embodiments, the wireless communication subsystem 1525 includes radio frequency receivers and transmitters, and optical receivers and transmitters (not shown in FIG. 15). These receivers and transmitters of some embodiments are implemented to operate over one or more communication networks such as a GSM network, a Wi-Fi network, a Bluetooth network, etc. The audio subsystem 1530 is coupled to a speaker to output audio (e.g., to output voice navigation instructions). Additionally, the audio subsystem 1530 is coupled to a microphone to facilitate voice-enabled functions, such as voice recognition (e.g., for searching), digital recording, etc.

The I/O subsystem 1535 involves the transfer between input/output peripheral devices, such as a display, a touch screen, etc., and the data bus of the processing units 1505 through the peripherals interface 1515. The I/O subsystem 1535 includes a touch-screen controller 1555 and other input controllers 1560 to facilitate the transfer between input/output peripheral devices and the data bus of the processing units 1505. As shown, the touch-screen controller 1555 is coupled to a touch screen 1565. The touch-screen controller 1555 detects contact and movement on the touch screen 1565 using any of multiple touch sensitivity technologies. The other input controllers 1560 are coupled to other input/control devices, such as one or more buttons. Some embodiments include a near-touch sensitive screen and a corresponding controller that can detect near-touch interactions instead of or in addition to touch interactions. Also, the input controller of some embodiments allows input through a stylus.

The memory interface 1510 is coupled to memory 1570. In some embodiments, the memory 1570 includes volatile memory (e.g., high-speed random access memory), non-volatile memory (e.g., flash memory), a combination of volatile and non-volatile memory, and/or any other type of memory. As illustrated in FIG. 15, the memory 1570 stores an operating system (OS) 1572. The OS 1572 includes instructions for handling basic system services and for performing hardware dependent tasks.

The memory 1570 also includes communication instructions 1574 to facilitate communicating with one or more additional devices; graphical user interface instructions 1576 to facilitate graphic user interface processing; image processing instructions 1578 to facilitate image-related processing and functions; input processing instructions 1580 to facilitate input-related (e.g., touch input) processes and functions; audio processing instructions 1582 to facilitate audio-related processes and functions; and camera instructions 1584 to facilitate camera-related processes and functions. The instructions described above are merely exemplary and the memory 1570 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 15 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 15 may be split into two or more integrated circuits.

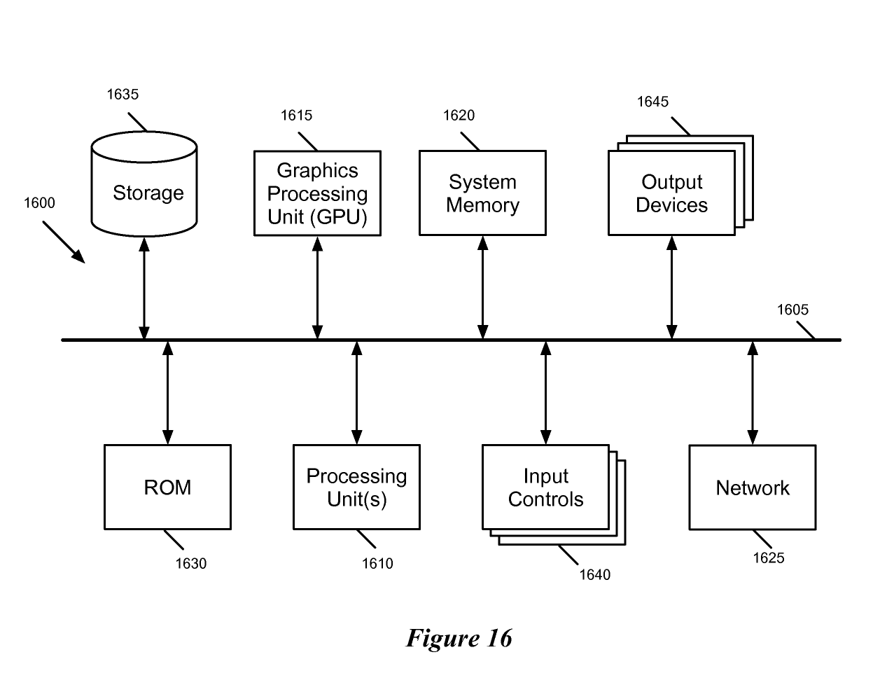

FIG. 16 conceptually illustrates another example of an electronic system 1600 with which some embodiments of the invention are implemented. The electronic system 1600 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1600 includes a bus 1605, processing unit(s) 1610, a graphics processing unit (GPU) 1615, a system memory 1620, a network 1625, a read-only memory 1630, a permanent storage device 1635, input devices 1640, and output devices 1645.

The bus 1605 collectively represents all system, peripheral, and chipset buses that communicatively connect the numerous internal devices of the electronic system 1600. For instance, the bus 1605 communicatively connects the processing unit(s) 1610 with the read-only memory 1630, the GPU 1615, the system memory 1620, and the permanent storage device 1635.

From these various memory units, the processing unit(s) 1610 retrieves instructions to execute and data to process in order to execute the processes of the invention. The processing unit(s) may be a single processor or a multi-core processor in different embodiments. Some instructions are passed to and executed by the GPU 1615. The GPU 1615 can offload various computations or complement the image processing provided by the processing unit(s) 1610.

The read-only-memory (ROM) 1630 stores static data and instructions that are needed by the processing unit(s) 1610 and other modules of the electronic system. The permanent storage device 1635, on the other hand, is a read-and-write memory device. This device is a non-volatile memory unit that stores instructions and data even when the electronic system 1600 is off. Some embodiments of the invention use a mass-storage device (such as a magnetic or optical disk and its corresponding disk drive, integrated flash memory) as the permanent storage device 1635.

Other embodiments use a removable storage device (such as a floppy disk, flash memory device, etc., and its corresponding drive) as the permanent storage device. Like the permanent storage device 1635, the system memory 1620 is a read-and-write memory device. However, unlike storage device 1635, the system memory 1620 is a volatile read-and-write memory, such a random access memory. The system memory 1620 stores some of the instructions and data that the processor needs at runtime. In some embodiments, the invention's processes are stored in the system memory 1620, the permanent storage device 1635, and/or the read-only memory 1630. For example, the various memory units include instructions for processing multimedia clips in accordance with some embodiments. From these various memory units, the processing unit(s) 1610 retrieves instructions to execute and data to process in order to execute the processes of some embodiments.

The bus 1605 also connects to the input and output devices 1640 and 1645. The input devices 1640 enable the user to communicate information and select commands to the electronic system. The input devices 1640 include alphanumeric keyboards and pointing devices (also called cursor control devices (e.g., mice)), cameras (e.g., webcams), microphones or similar devices for receiving voice commands, etc. The output devices 1645 display images generated by the electronic system or otherwise output data. The output devices 1645 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 16, bus 1605 also couples electronic system 1600 to a network 1625 through a network adapter (not shown). In this manner, the computer can be a part of a network of computers (such as a local area network (“LAN”), a wide area network (“WAN”), or an Intranet), or a network of networks, such as the Internet. Any or all components of electronic system 1600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

We claim:

1. A method comprising:
on a display screen, displaying a document with a plurality of candidate cinemagraph presentations for display;
based on a set of at least two criteria, selecting at least one candidate cinemagraph presentation for display; and
displaying the selected cinemagraph presentation with the document.

2. The method of claim 1, wherein the criteria include a set of preferences of a viewer of the document.

3. The method of claim 2, wherein the set of preferences is specified by the viewer.

4. The method of claim 3,
wherein displaying the document comprises generating an output display for the display screen, said output display comprising the document,
wherein a machine-executable program generates the output display,
wherein the program receives the set of preferences from the viewer before generating the output display.

5. The method of claim 2, wherein the set of preferences is detected based on past interactions with the viewer.

6. The method of claim 1, wherein the criteria include a set of preferences of at least one publisher of at least one candidate cinemagraph presentations, wherein the set of publisher preferences includes a set of preferences for display of the publisher's cinemagraph presentation to a viewer that matches a certain viewer profile.

7. The method of claim 1, wherein selecting the cinemagraph presentation comprises selecting the cinemagraph presentation because it was available for display with the document more recently than a plurality of other candidate cinemagraph presentations.

8. The method of claim 1, wherein the criteria include positional relationship of the cinemagraph presentations with respect to an area of the display screen.

9. The method of claim 8, wherein the display-screen area is an area to which a viewer's attention should be drawn.

10. The method of claim 8, wherein the display-screen area is an area to which a viewer's attention is expected to focus on initially on the display screen.

11. The method of claim 1, wherein selecting the cinemagraph presentation comprises:
computing a score for each candidate cinemagraph for each of a plurality of criteria;
from the computed scores, computing a weighted aggregate score for each candidate cinemagraph; and
selecting the candidate cinemagraph presentation based on the weighted aggregate scores.

12. A method comprising:
in a display output generated by a device, displaying a document comprising at least one cinemagraph presentation;
through at least one motion sensor of the device, detecting motion of the device; and
displaying the cinemagraph presentation based on the detected motion.

13. The method of claim 12 further comprising:
displaying the cinemagraph presentation before detecting the device motion,
wherein displaying the cinemagraph presentation based on the detected motion comprises modifying the displayed cinemagraph presentation based on the detected motion.

14. The method of claim 12, wherein the cinemagraph presentation is not displayed before detected device motion, wherein the motion sensor is one of a gyroscope and an accelerometer.

15. A method comprising:
on a display screen of a device, displaying a document comprising at least one cinemagraph presentation;
receiving scroll input for scrolling content on the display screen; and
playing the cinemagraph presentation based on the scroll input.

16. The method of claim 15 further comprising:
playing the cinemagraph presentation before receiving the scroll input,
wherein playing the cinemagraph presentation based on the scroll input comprises modifying the cinemagraph presentation based on the scroll input.

17. The method of claim 15, wherein the cinemagraph presentation is not played before receiving the scroll input.

18. The method of claim 17,
wherein the document further comprises an image display section for playing the cinemagraph presentation,
wherein before the cinemagraph presentation is played in the image display section, the image display section displays one image.

19. A method comprising:
on a display screen, displaying a first document that is associated with a second document; and
in response to a request for the second document, providing an animated transition from the first document to the second document, said animated transition comprising a cinemagraph presentation.

20. The method of claim 19,
wherein the first document comprises a first cinemagraph presentation, the second document comprises a second cinemagraph presentation and the cinemagraph presentation of the animated transition is a third cinemagraph presentation,
wherein the first, second and third cinemagraph presentations are related cinemagraph presentations.

21. The method of claim 20, wherein the first, second and third cinemagraph presentations are related cinemagraph presentations relate to one subject matter.

22. The method of claim 20, wherein the first, second and third cinemagraph presentations are identical.

23. The method of claim 20, wherein each cinemagraph presentation has a plurality of images for sequential display, and has at least one image in common with at least one other cinemagraph presentation.

24. The method of claim 19,
wherein at least one document comprises a first cinemagraph presentation,
wherein the cinemagraph presentation of the animated transition is a second cinemagraph presentation,
wherein the first and second cinemagraph presentations relate to one subject matter.

25. The method of claim 24, wherein the first and second cinemagraph presentations are identical.

26. The method of claim 24, wherein each cinemagraph presentation has a plurality of images for sequential display, and has at least one image in common with the other cinemagraph presentation.

27. The method of claim 19,
wherein the cinemagraph presentation of the animated transition is a first cinemagraph presentation,
wherein the second document comprises a second cinemagraph presentation,
wherein each cinemagraph presentation has a plurality of images for sequential display,
wherein the second cinemagraph presentation includes the plurality of images of the first cinemagraph presentation and another plurality of images.

28. The method of claim 19,
wherein the first document comprises a first cinemagraph presentation, the second document comprises a second cinemagraph presentation and the cinemagraph presentation of the animated transition is a third cinemagraph presentation,
wherein the first cinemagraph presentation is displayed in a first image section of the first document and the second cinemagraph presentation is displayed in a second image section of the second document, said second image section having a different size than the first image section,
wherein providing the animate transition comprises adjusting the size of the third cinemagraph presentation from an initial size defined by a first size of the first cinemagraph presentation to a second size of the second cinemagraph presentation, while playing the third cinemagraph presentation.
